(19) United States
(12) Patent Application Publication
(10) Pub. No.: US 2023/0317441 A1
(43) Pub. Date: Oct. 5, 2023

(54) Analysis of time-of-flight mass spectra

(71) Applicant: Thermo Fisher Scientific (Bremen) GmbH, Bremen (DE)

(72) Inventors: Bernd Hagedorn, Bremen (DE); Dmitry Grinfeld, Bremen (DE); Hamish Stewart, Bremen (DE); Ankit Dwivedi, Bremen (DE)

(21) Appl. No.: 18/128,221

(22) Filed: Mar. 30, 2023

(30) Foreign Application Priority Data
Mar. 30, 2022 (GB) 2204525

(51) Int. Cl. H01J 49/00

(52) U.S. Cl. CPC H01J 49/0036

(57) ABSTRACT

A method of analysing data generated by an ion analyser comprises (i) receiving a segment of data generated by an ion analyser, wherein the segment of data comprises data associated with a first arrival time range, and (ii) applying a filter to the segment of data so as to produce a filtered version of the segment of data. A width associated with the filter is configured to depend upon a width of an expected ion arrival time distribution for the ion analyser for arrival times within the first arrival time range. The method further comprises (iii) identifying one or more ion peaks in the filtered version of the segment of data, and then (iv) determining one or more characteristics of each ion peak of the one or more identified ion peaks.

### CROSS-REFERENCE TO RELATED APPLICATIONS

This application claims priority to United Kingdom Application No. GB2204525, filed Mar. 30, 2022, the entire contents of which is incorporated herein by reference.

### FIELD OF THE INVENTION

The present invention relates to methods of analysing ions, and in particular to time-of-flight mass spectrometry (ToF-MS) and time-of-flight (ToF) analysers.

### BACKGROUND

Time-of-flight (ToF) mass analysers utilise the property that the travelling time of an ion in an electrostatic field is proportional to the square root of the ion's mass-to-charge ratio (m/z). Ions are ejected from an ion source, accelerated to a desired energy, and impinge upon an ion detector after traveling a specified distance. The signal generated by the detector is recorded, and typically results in time resolved peaks generated by ions having the same mass-to-charge ratio (m/z). With the travelling distance substantially the same for all ions, an ion's arrival time is used to determine its mass-to-charge ratio (m/z), which can later be used for identification.

ToF mass analysers typically record spectra at a rate of between around 100 Hz and 10 kHz, with each spectrum potentially containing hundreds or thousands of different ion peaks. It can be desirable to analyse these spectra in real-time, e.g. so that the parameters for subsequent scans can be set based on the results of the analysis.

It is believed that there remains scope for improvements to apparatus and methods for time-of-flight mass analysis.

### SUMMARY

A first aspect provides a method of analysing data generated by an ion analyser, the method comprising:
(i) receiving a segment of data generated by the ion analyser, wherein the segment of data comprises data associated with a first arrival time range;
(ii) applying a filter to the segment of data so as to produce a filtered version of the segment of data, wherein a width associated with the filter is configured to depend upon a width of an expected ion arrival time distribution for the ion analyser for arrival times within the first arrival time range;
(iii) identifying one or more ion peaks in the filtered version of the segment of data; and then
(iv) determining one or more characteristics of each ion peak of the one or more identified ion peaks.

Embodiments provide methods of analysing data generated by an ion analyser such as a time-of-flight mass analyser. The ion analyser may comprise an ion detector arranged at the end of an ion path. A packet of ions may be injected into the ion path, whereupon the ions may travel along the ion path to the detector for detection. The detector may be configured to produce a signal indicative of an ion intensity received at the detector as a function of (arrival) time. This signal may be digitised to produce a collection of digital samples, where each sample includes an intensity value and is associated with a respective arrival time. The signal and/or collection of samples (and the arrival times associated with the signal and/or collection of samples) may span most or all of the arrival time range for the particular packet of ions that produced the signal.

In the method, each signal and/or collection of samples (that is generated due to a respective packet of ions) is processed by (separately) processing each segment of one or more segments that the signal and/or collection is divided into. For example, each segment may comprise a sub-set of samples of the (entire) collection of samples generated in respect of a packet of ions. Each segment may comprise a (contiguous) set of samples, where the arrival times for the samples of the segment are all within a respective arrival time range for that segment. Each arrival time range for each of the one or more segments may be a sub-range of the (entire) arrival time range for the particular packet of ions that produced the signal.

In the method, each segment of data is (separately) processed by applying a filter to the segment. A width associated with the filter (such as a width of a smoothing kernel or a width of a wavelet) is selected in respect of each segment, e.g., such that the width is different for each different segment that the signal and/or the collection of samples is divided into. In particular, the width is configured to depend upon a width of an expected ion arrival time distribution for ions having arrival times within the arrival time range associated with that segment. The width of the expected arrival time distribution typically depends on the arrival time itself, and so the width associated with the filter for each segment may depend upon (e.g., may be proportional to) the arrival time range associated with that segment, and in particular may depend upon (e.g., may be proportional to) the mean arrival time associated with that segment.

After a segment has been filtered in this manner, the filtered version of the segment is used to identify one or more ion peaks within that segment, and then one or more characteristic(s) of each of the identified ion peak(s) (e.g., its centroid, intensity, and/or area, etc.) is determined, e.g. by fitting a suitable ion peak model to the original unfiltered segment (and/or to the filtered version of the segment).

As will be described in more detail below, filtering each segment using a filter that has a width that depends upon the width of an expected ion arrival time distribution for the segment is particularly advantageous in circumstances where the widths of individual ion peaks recorded by the ion detector can be less than the width of an expected ion arrival time distribution for a particular ion species. In these circumstances, where the ion flux at the detector is relatively low, the ion detector can produce a multi-modal signal in respect of a single ion species due to individual ions of the same species arriving at the detector with slightly different arrival times that are within the expected arrival time distribution for that species. The presence of such multi-modal peaks in the signal could lead to the identification of multiple distinct ion peaks in the signal, which could then be incorrectly identified as belonging to multiple distinct ion species.

In embodiments, the filter has the effect of smoothing a multi-modal signal that is produced by ions of the same species into a unimodal signal, while retaining any multi-modal signal(s) that are produced from ions of different species. This then ensures that the filtered version of the segment of data will (usually) include only one ion peak in respect of each ion species. This in turn allows improved identification and characterisation of the ion species that are present within a particular packet of ions.

Moreover, as will be described in more detail below, the various steps of the method are all relatively computationally inexpensive and can be implemented in an efficient manner. This allows the identification and characterisation of ion peaks to be performed in real-time, even where spectra are being produced at relatively high rates (>100 Hz), as is typically the case for time-of-flight mass analysers.

Thus, embodiments provide an improved method of analysing data generated by an ion analyser, which is particularly robust in accurately identifying and charactering ion peaks, and which can be run in real-time, i.e., alongside the collection of the data at high rates (>100 Hz).

The ion analyser can be any suitable ion analyser, such as a time-of-flight (ToF) mass analyser configured to determine the mass to charge ratio (m/z) of ions from their arrival times, or an ion mobility analyser configured to determine the ion mobility of ions from their arrival times.

In particular embodiments, the ion analyser is a multi-reflection time-of-flight (MR-ToF) analyser, such as a titled-mirror type multi-reflection time-of-flight mass analyser, e.g. of the type described in U.S. Pat. No. 9,136,101, or a single focusing lens type multi-reflection time-of-flight mass analyser, e.g. of the type described in UK patent No. 2,580,089.

The ion analyser may form part of an analytical instrument. The analytical instrument may be a mass spectrometer, an ion mobility spectrometer, or a combination of the two (e.g. a mass spectrometer which includes an ion mobility separator). The instrument may comprise an ion source. Ions may be generated from a sample in the ion source. The ions may be passed from the ion source to the analyser via one or more ion optical devices arranged between the ion source and the analyser.

The one or more ion optical devices may comprise any suitable arrangement of one or more ion guides, one or more lenses, one or more gates, and the like. The one or more ion optical devices may include one or more transfer ions guides for transferring ions, and/or one or more mass selector or filters for mass selecting ions, and/or one or more ion cooling ion guides for cooling ions, and/or one or more collision or reaction cells for fragmenting or reacting ions, and so on. One or more or each ion guide may comprise an RF ion guide such as a multipole ion guide (e.g. quadrupole ion guide, hexapole ion guide, etc.), a segmented multipole ion guide, a stacked ring type ion guide, and the like.

The ion analyser may comprise an ion injector arranged at the start of an ion path, and an ion detector arranged at the end of the ion path. The ion analyser may be configured to analyse ions by determining arrival times of ions at the detector (i.e., the time taken for ions to travel from the injector and to arrive at the detector via the ion path).

The ion injector can be in any suitable form, such as for example an ion trap, or one or more (e.g., orthogonal) acceleration electrodes. The ion injector may be configured to receive ions (from the ion source via the one or more ion optical devices), and may optionally be configured to accumulate a packet of ions (e.g. by accumulating ions during an accumulation time period). The ion injector may be configured to inject a (received and/or accumulated) packet ions into the ion path (e.g. by accelerating the packet of ions along the ion path), whereupon the ions of the packet may travel along the ion path to the detector.

The detector can be any suitable ion detector such as one or more conversion dynodes, optionally followed by one or more electron multipliers, one or more scintillators, and/or one or more photon multipliers, and the like. The detector may be configured to detect ions received at the detector, and may be configured to produce a signal indicative of an intensity of ions received at the detector as a function of (arrival) time.

Each signal is produced from a (single) packet of ions. Multiple such packets of ions may be sequentially injected into the ion path and detected by the detector. Thus, the method may comprise repeatedly: (i) injecting a packet of ions into the ion path, (ii) detecting the packet of ions at the detector, and (iii) producing a respective signal for the packet of ions. Packets of ions may be injected into the ion path (and signals may be produced) at any desired rate, such as at a rate greater than around 100 Hz and less than around 10 kHz, e.g. around 200 Hz. Each signal will have a respective ion arrival time range associated with it.

The detector can include a digitiser, such as a time-to-digital converter (TDC) or an analogue-to-digital converter (ADC), which may be configured to digitise each signal so as to produce a collection of digital samples. The digitiser may have a single channel, or multiple channels e.g. where the signal from the detector is split between a first high gain channel and a second low gain channel (to increase the dynamic range).

Each collection of digital samples may be produced from the signal in respect of a single packet of ions. Thus, the method may comprise repeatedly: (i) injecting a packet of ions into the ion path, (ii) detecting the packet of ions, (iii) producing a respective signal for the packet of ions, and (iv) digitising the signal to produce a respective collection of digital samples for the packet of ions. Alternatively, each collection of digital samples may be produced from the signal in respect of multiple packets of ions (i.e. multiple ion injections), whereby the multiple signals and/or samples are combined (e.g. averaged). Thus, the method may comprise repeating steps (i) to (iv) multiple times, and combining (e.g., averaging) the digital samples to produce a collection of digital samples for further analysis.

Each digital sample in each collection is associated with a respective arrival time and will include an intensity value indicative of an ion intensity measured by the detector at the particular arrival time. Different arrival times are indicative of different values of an associated physicochemical property, such as mass to charge ratio (m/z) or ion mobility. Digital samples can be stored and processed in a form that includes an intensity value and an arrival time value, but it would also be possible for digital samples to be stored and processed in a form that includes an intensity value and a value of the associated physicochemical property (e.g. m/z). The arrival times associated with each collection of samples may span most or all of the arrival time range for the related signal.

In embodiments, each signal and/or collection of samples is divided into one or more segments, e.g. plural segments. Each segment may comprise a sub-set of the signal generated in respect of a packet of ions, e.g. a sub-set of digital samples of an (entire) collection of digital samples generated in respect of a packet of ions (or a sub-set of digital samples of a collection produced by combining (e.g. averaging) signals from multiple packets of ions). In particular, each segment may comprise a (non-overlapping) contiguous portion of the signal (e.g., a (contiguous) set of digital samples), where the arrival times for the (samples of the) segment are all within a respective arrival time range for that segment.

Thus, each segment of data may comprise a respective set of digital samples, wherein each sample of the set is associated with a respective arrival time, and wherein the arrival times associated with the set are within a respective arrival time range. For example, a signal may be divided into a first segment comprising a first set of digital samples wherein the arrival times associated with the first set are within a first arrival time range, and a second segment comprising a second set of digital samples wherein the arrival times associated with the second set are within a second different arrival time range. The signal may optionally also be divided into one or more further segments, each comprising a respective further set of digital samples wherein the arrival times associated with each respective further set are within a respective further different arrival time range.

Each arrival time range for each of the segments that a signal and/or collection of samples is divided into may be a sub-range of the (overall) arrival time range for the signal. The arrival time ranges for the plural segments that the signal/collection is divided into may be a set of non-overlapping arrival time ranges, i.e. each arrival time range for each of the segments may be a non-overlapping sub-range of the overall arrival time range.

The signal can be divided into plural segments in any suitable manner. The signal can be divided into plural segments before digitisation or after digitisation. In particular embodiments, the signal is divided into plural segments as part of the digitisation process, e.g., digital samples are output from the digitiser in the form of segments (i.e., sets of digital samples).

In some embodiments, the signal and/or collection of digital samples can be divided into equally sized, non-overlapping, adjacent segments (i.e. in a data-independent manner).

However, in particular embodiments, the signal and/or the collection of digital samples is divided into plural segments in a data-dependent manner. In particular, segment(s) may be generated when the ion intensity exceeds a threshold. For example, a segment may begin when the intensity of a sample exceeds a first threshold and may end when the intensity of a sample drops below a second threshold. The first and second thresholds may be the same or may be different. Where the intensity drops below the second threshold only briefly, the segment may be continued. This may be achieved, for example, by configuring the digitiser such that a segment is ended only if the threshold remains below the second threshold for a certain number of samples. It would also be possible for a segment to begin a certain number of samples before the intensity of a sample exceeds the first threshold and/or to end a certain number of samples after the signal falls below the second threshold.

It will be understood that by dividing the signal and/or the collection of digital samples into plural segments in the manner of various embodiments, some or most samples within a segment will have an intensity value above a threshold. Other regions of the signal may be discarded. In this way, it can be ensured that each segment includes data in respect of one or more ion peaks (and that regions of the signal that are empty of ion peaks are discarded).

In the method, each segment of data is (separately) processed by applying a filter to the segment. In embodiments, the filter is applied to each segment after digitisation, i.e. the filter is applied to each set of digital samples.

A width δt (e.g. full width at half maximum (FWHM)) associated with the filter (such as a width (e.g. FWHM) of a smoothing kernel or wavelet) is selected in respect of each segment, e.g., such that the width δt is different for each different segment that the signal is divided into. In particular, the width δt is configured to depend upon a width of an expected ion arrival time distribution for ions having arrival times within the arrival time range associated with that segment. The expected ion arrival time distribution for the ion analyser may be determined, for example, by performing a suitable calibration for the ion analyser.

The width of the expected arrival time distribution may depend on the arrival time itself, and so the width δt associated with the filter for each segment may depend upon the arrival time range associated with that segment, and in particular may depend upon the mean arrival time T associated with that segment. The dependency may take any suitable form, such as for example being a linear (proportional) dependency (i.e. δt∝T) or a non-linear dependency.

In embodiments, the filter has the effect of smoothing any multi-modal ion peak produced by ions of the same species into a unimodal ion peak, while retaining any multi-modal ion peak(s) produced by ions of different species. This ensures that the filtered version of the segment of data will (usually) include only one ion peak in respect of each ion species.

In embodiments, the filter utilises a smoothing kernel. The smoothing kernel may take any suitable form. In embodiments, the smoothing kernel has the form of a Gaussian. Alternatively, the smoothing kernel may be more closely modelled on the expected arrival-time distribution for the instrument (e.g. which may be determined from a calibration). For example, the smoothing kernel may take the form of an asymmetric Gaussian, e.g. with different widths to the left and right of its centre.

In alternative embodiments, the filter is a continuous wavelet transformation (CWT), i.e. where the scale of the wavelet may again depend upon (e.g. may be proportional to) the arrival time range associated with the segment, e.g. the mean arrival time T associated with the segment. Any suitable wavelet may be used, such as for example the Marr wavelet.

After a segment has been filtered, the filtered version of the segment is used to identify one or more ion peaks within that segment. This may be done in any suitable manner.

Where the filter is a smoothing function, the method may comprise identifying one or more local minima in the filtered signal, and then dividing the segment into one or more intervals at the location of each of the identified minima (e.g. if a minimum is below a specified threshold). Where the filter is a continuous wavelet transformation (CWT), the method may comprise identifying one or more local maxima in the filtered signal, and then dividing the segment into one or more intervals at the location of each of the identified maxima (e.g. if a maximum is above a specified threshold). In general, depending on the nature of the filter, the method may comprise identifying one or more local minima, zero-crossing points and/or local maxima in the filtered signal, and then dividing the segment into one or more intervals at the location of each of the identified minima, zero-crossing points and/or maxima. Splitting at a local minimum or maximum may be done only if the minimum or the maximum exceeds (or is below) a threshold.

The method may comprise retaining or discarding each interval based on the maximum intensity of the samples within that interval. For example, the method may comprise retaining an interval where the maximum intensity of that interval's samples is above a threshold, and discarding an interval where the maximum intensity of that interval's samples is below the threshold. Thus, the method may comprise retaining only those interval(s) with a maximum sample intensity above a threshold (and discarding any other interval(s)).

It will be understood that these steps ensure that, at this stage, where only one ion peak is present in a segment, only a single interval will remain of that segment. In this case, the method may proceed by determining one or more characteristics (e.g. centroid, intensity, and/or area, etc.) of the ion peak by analysing the unfiltered and/or filtered data in this interval. This may be done by way of fitting a suitable (single) peak model to the samples of the interval. Any suitable peak model may be used, such as for example a Gaussian or an asymmetric Gaussian.

Where multiple intervals remain for a segment, the method may continue by processing each interval one by one. In embodiments, the sum of the intensities of each interval's samples is calculated, and the intervals are then sorted in accordance with the calculated sum for each interval, e.g. from highest to lowest.

The method may comprise fitting a (first) single peak model to the samples of the (first) interval with the highest sum. Next, for the (second) interval with the next highest sum, that interval's samples may be modified using the first peak model (at least to the extent that the first peak model overlaps the second interval). For example, intensity values determined from the first peak model may be respectively subtracted from corresponding intensity values of one or more or each of the samples of the second interval, e.g. so as produce a set of modified samples for the second interval. The method may continue by fitting a (second) single peak model to the modified samples of the second interval.

This process may continue for any remaining interval(s) of the segment in order from the interval with the highest sum to the interval with the lowest sum, whereby the samples of each interval are firstly (a) modified using each (and every) peak model that has already been determined for other intervals of that segment (at least to the extent that the peak model in question overlaps the interval in question). This may comprise subtracting intensity value(s) determined from the existing peak model(s) from corresponding intensity values of one or more or each of the samples of the current interval, e.g. so as produce a set of modified samples for the current interval. The method may comprise then (b) fitting a (single) peak model to the modified samples of the current interval. In this way, one or more characteristics (e.g. centroid, intensity, and/or area, etc.) of each of multiple ion peaks in the segment may be determined. Again, any suitable (single) peak model may be used for each interval, such as for example a Gaussian or an asymmetric Gaussian.

In further embodiments, when the above-described process has been completed for all of the (retained) intervals of a segment, the peak model fitting process may optionally be iterated. This may be done by modifying the samples of the first interval using each (and every) peak model produced for the other intervals in the segment. This may comprise subtracting intensity value(s) determined from those peak model(s) from corresponding intensity values of one or more or each of the samples of the first interval, e.g. so as produce a set of modified samples for the first interval. The method may comprise fitting a modified first peak model to the modified samples of the first interval. Then, the method may continue as described above, but where the modified first peak model is used in place of the first peak model, and where in each step, each interval's samples are modified using all of the (most current) peak model(s) produced in respect of the other intervals in the segment.

Thus, the method may comprise, when a set of peak models has been produced by fitting a peak model to each of the multiple remaining intervals: (c) using the peak models of the set other than the first peak model to modify the samples of the interval with the highest sum; (d) fitting a first modified peak model to the modified samples of the interval with the highest sum, and replacing the first peak model with the first modified peak model in the set of peak models; (e) using the peak models of the set other than the second peak model to modify the samples of the interval with the second highest sum; and (f) fitting a second modified peak model to the modified samples of the interval with the second highest sum, and replacing the second peak model with the second modified peak model in the set of peak models. The method may optionally further comprise (g) for each (and every) interval of any remaining interval(s) of the segment other than the interval with the highest sum and the interval with the second highest sum, performing the steps (h) and (i): (h) modifying the samples of the interval with the next highest sum using the peak models of the set other than the peak model for the current interval; and (i) fitting a peak model to the modified samples of the current interval, and replacing the peak model for the current interval with the modified peak model for the current interval in the set of peak models.

In embodiments, this iteration process (i.e. steps (c) to (i)) can be repeated one or plural times, as desired. The iteration(s) may be terminated, for example, when the model parameters have reached a desired precision or when a defined maximum number of iterations has been reached.

As an optional final step, the method may comprise performing a (nonlinear) fit of the full segment, e.g. using a multiple-peak model. The initial values for this fit may be derived from the single ion peak model(s) determined in the previous step(s). This step may increase the accuracy of the various determined characteristics, at the expense of additional processing time. In some embodiments, this step is not performed, as it has been found that sufficient accuracy can be obtained without this step.

Once one or more final models have been determined for the segment, the one or more peak models may each be used to determine one or more characteristics of each ion peak in the segment, such as its centroid, intensity and/or area. The one or more characteristics of each ion peak can then be used as desired. For example, a physicochemical property of each ion in the segment, such as its mass to charge ratio and/or ion mobility, may be determined.

A further aspect provides a non-transitory computer readable storage medium storing computer software code which when executed on a processor performs the method(s) described above.

A further aspect provides a control system for an analytical instrument such as a mass and/or ion mobility spectrometer, the control system configured to cause the analytical instrument to perform the method(s) described above.

A further aspect provides an analytical instrument comprising an ion analyser and the control system described above.

A further aspect provides an analytical instrument comprising:
an ion analyser; and
a control system configured to:
(i) receive a segment of data generated by the ion analyser, wherein the segment of data comprises data associated with a first arrival time range;
(ii) apply a filter to the segment of data so as to produce a filtered version of the segment of data, wherein a width associated with the filter is configured to depend upon a width of an expected ion arrival time distribution for the ion analyser for arrival times within the first arrival time range;
(iii) identify one or more ion peaks in the filtered version of the segment of data; and then
(iv) determine one or more characteristics of each ion peak of the one or more identified ion peaks.

These aspects and embodiments can, and in embodiments do, include any one or more or each of the optional features described herein.

Thus, for example, the analytical instrument may be a mass and/or ion mobility spectrometer. The ion analyser may be a time-of-flight (ToF) mass analyser such as a multi-reflection time-of-flight (MR-ToF) analyser.

### DESCRIPTION OF THE DRAWINGS

Various embodiments will now be described in more detail with reference to the accompanying Figures, in which:

FIG. 1 shows schematically an analytical instrument in accordance with embodiments;

FIG. 2 shows schematically a multi-reflection time-of-flight mass analyser in accordance with embodiments;

FIG. 3 illustrates schematically a process of detecting ions in an ion analyser in accordance with embodiments;

FIG. 4A shows a digitised signal which includes ion peaks corresponding to two different ion species, and FIG. 4B shows a digitised signal which includes ion peaks corresponding to a signal ion species;

FIG. 5 shows schematically a method in accordance with embodiments;

FIG. 6 illustrates the method of FIG. 5 for a signal which includes ion peaks corresponding to two different ion species;

FIG. 7 illustrates the method of FIG. 5 for a signal which includes ion peaks corresponding to a single ion species;

FIG. 8 shows schematically a method in accordance with embodiments;

FIG. 9 illustrates the convergence of the estimated centroid and peak area during iteration of the method in accordance with embodiments using the example data of FIG. 6;

FIG. 10 shows split success rate as a function of distance between two peaks for the method in accordance with embodiments;

FIG. 11 shows number of false positives as a function of distance between two peaks for the method in accordance with embodiments;

FIG. 12 shows split success rate as a function of distance between two peaks for the method in accordance with embodiments;

FIG. 13 shows number of false positives as a function of distance between two peaks for the method in accordance with embodiments; and

FIG. 14 shows accuracy as a function of distance between two peaks for the method in accordance with embodiments.

### DETAILED DESCRIPTION

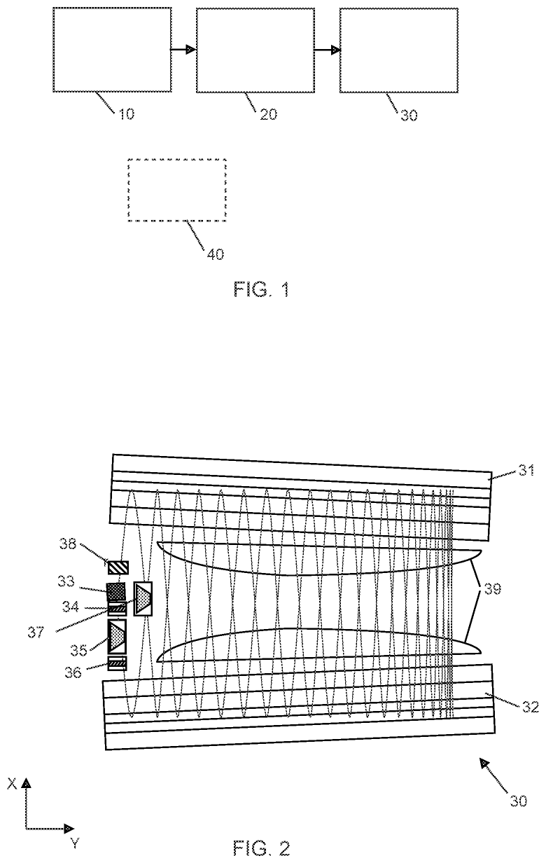

FIG. 1 illustrates schematically an analytical instrument that may be operated in accordance with embodiments. The analytical instrument may be a mass spectrometer (which can optionally include an ion mobility separator) or an ion mobility spectrometer. As shown in FIG. 1, the analytical instrument includes an ion source 10, one or more ion transfer stages 20, and an analyser 30.

The ion source 10 is configured to generate ions from a sample. The ion source 10 can be any suitable continuous or pulsed ion source, such as an electrospray ionisation (ESI) ion source, a MALDI ion source, an atmospheric pressure ionisation (API) ion source, a plasma ion source, an electron ionisation ion source, a chemical ionisation ion source, and so on. In some embodiments, more than one ion source may be provided and used. The ions may be any suitable type of ions to be analysed, e.g. small and large organic molecules, biomolecules, DNA, RNA, proteins, peptides, fragments thereof, and the like.

The ion source 10 may optionally be coupled to a separation device such as a liquid chromatography separation device or a capillary electrophoresis separation device (not shown), such that the sample which is ionised in the ion source 10 comes from the separation device.

The ion transfer stage(s) 20 are arranged downstream of the ion source 10 and may include an atmospheric pressure interface and one or more ion guides, lenses and/or other ion optical devices configured such that some or most of the ions generated by the ion source 10 can be transferred from the ion source 10 to the analyser 30. The ion transfer stage(s) 20 may include any suitable number and configuration of ion optical devices, for example optionally including any one or more of: one or more RF and/or multipole ion guides, one or more ion guides for cooling ions, one or more mass selective ion guides, and so on.

The analyser 30 is arranged downstream of the ion transfer stage(s) 20 and is configured to receive ions from the ion transfer stage(s) 20. The analyser is configured to analyse the ions so as to determine a physicochemical property of the ions, such as their mass to charge ratio, mass, ion mobility and/or collision cross section (CCS). To do this, the analyser 30 is configured to pass ions along an ion path within the analyser 30, and to measure the time taken (the drift time) for ions to pass along the ion path. Thus, the analyser 30 can comprise an ion detector arranged at the end of the ion path, wherein the analyser is configured to record the time of arrival of ions at the detector. The instrument may be configured to determine the physicochemical property of the ions from their measured arrival time. The instrument may be configured produce a spectrum of the analysed ions, such as a mass spectrum or an ion mobility spectrum.

In particular embodiments, the analyser 30 is a time-of-flight (ToF) mass analyser, e.g. configured to determine the mass to charge ratio (m/z) of ions by passing the ions along an ion path within a drift region of the analyser, where the drift region is maintained at high vacuum (e.g. <1×10⁻⁵ mbar). Ions may be accelerated into the drift region by an electric field, and may be detected by an ion detector arranged at the end of the ion path. The acceleration may cause ions having a relatively low mass to charge ratio to achieve a relatively high velocity and reach the ion detector prior to ions having a relatively high mass to charge ratio. Thus, ions arrive at the ion detector after a time determined by their velocity and the length of the ion path, which enables the mass to charge ratio of the ions to be determined. Each ion or group of ions arriving at the detector may be sampled by the detector, and the signal from the detector may be digitised. A processor may then determine a value indicative of the time of flight and/or mass-to-charge ratio (“m/z”) of the ion or group of ions. Data for multiple ions may be collected and combined to generate a time of flight (“ToF”) spectrum and/or a mass spectrum.

In alternative embodiments, the analyser 30 is an ion mobility analyser, e.g. configured to determine the ion mobility of ions by passing the ions along an ion path within a drift region of the analyser, where a buffer gas is provided in the drift region. Ions may be urged through the buffer gas by an electric field (or ions may be urged through the drift region by a gas flow where an electric field is arranged to oppose the gas flow), and may be detected by an ion detector arranged at the end of the ion path. Ions having a relatively high mobility will reach the ion detector prior to ions having a relatively low mobility. Thus, ions may separate according to their ion mobility, and may arrive at the ion detector with an arrival time determined by their ion mobility. Each ion or group of ions arriving at the detector may be sampled by the detector, and the signal from the detector may be digitised. A processor may then determine a value indicative of the arrival time and/or ion mobility of the ion or group of ions. Data for multiple ions may be collected and combined to generate an arrival time spectrum and/or an ion mobility spectrum.

It should be noted that FIG. 1 is merely schematic, and that the analytical instrument can, and in embodiments does, include any number of one or more additional components. For example, in some embodiments, the analytical instrument includes a collision or reaction cell for fragmenting or reacting ions, and the ions analysed by the analyser 30 can be fragment or product ions produced by fragmenting or reacting parent ions generated by the ion source 10.

As also shown in FIG. 1, the instrument is under the control of a control unit 40, such as an appropriately programmed computer, which controls the operation of various components of the instrument including the analyser 30. The control unit 40 may also receive and process data from various components including the detector(s) in accordance with embodiments described herein.

FIG. 2 illustrates schematically detail of one exemplary embodiment of the analyser 30. In this embodiment, the analyser 30 is a multi-reflecting time-of-flight (MR-ToF) mass analyser.

As shown in FIG. 2, the multi-reflection time-of-flight analyser 30 includes a pair of ion mirrors 31, 32 that are spaced apart and face each other in a first direction X. The ion mirrors 31, 32 are elongated along an orthogonal drift direction Y between a first end and a second end.

An ion source (injector) 33, which may be in the form of an ion trap, is arranged at one end (the first end) of the analyser. The ion source 33 may be arranged and configured to receive ions from the ion transfer stage(s) 20. Ions may be accumulated in the ion source 33, before being injected into the space between the ion mirrors 31, 32. As shown in FIG. 2, ions may be injected from the ion source 33 with a relatively small injection angle or drift direction velocity, creating a zig-zag ion trajectory, whereby different oscillations between the mirrors 31, 32 are separate in space.

One or more lenses and/or deflectors may be arranged along the ion path, between the ion source 33 and the ion mirror 32 first encountered by the ions. For example, as shown in FIGS. 2, a first out-of-plane lens 34, an injection deflector 35, and a second out-of-plane lens 36 may be arranged along the ion path, between the ion source 33 and the ion mirror 32 first encountered by the ions. Other arrangements would be possible. In general, the one or more lenses and/or deflectors may be configured to suitably condition, focus and/or deflect the ion beam, i.e. such that it is caused to adopt the desired trajectory through the analyser.

The analyser also includes another deflector 37, which is arranged along the ion path, between the ion mirrors 31, 32. As shown in FIG. 2, the deflector 37 may be arranged approximately equidistant between the ion mirrors 31, 32, along the ion path after its first ion mirror reflection (in ion mirror 32), and before its second ion mirror reflection (in the other ion mirror 31).

The analyser also includes a detector 38. The detector 38 can be any suitable ion detector configured to detect ions, and e.g. to record an intensity and time of arrival associated with the arrival of ion(s) at the detector. Suitable detectors include, for example, one or more conversion dynodes, optionally followed by one or more electron multipliers, and the like.

To analyse ions, ions may be injected from the ion source 33 into the space between the ion mirrors 31, 32, in such a way that the ions adopt a zigzag ion path having plural reflections between the ion mirrors 31, 32 in the X direction, whilst: (a) drifting along the drift direction Y towards the opposite (second) end of the ion mirrors 31, 32, (b) reversing drift direction velocity in proximity with the second end of the ion mirrors 31, 32, and then (c) drifting back along the drift direction Y to the deflector 37. The ions can then be caused to travel from the deflector 37 to the detector 38 for detection.

In the analyser of FIG. 2, the ions mirrors 31, 32 are both tilted with respect to the X and/or drift Y direction. It would instead be possible for only one of the ion mirrors 31, 32 to be tilted, and e.g. for the other one of the ion mirrors 31, 32 to be arranged parallel to the drift Y direction. In general, the ion mirrors are a non-constant distance from each other in the X direction along their lengths in the drift direction Y. The drift direction velocity of ions towards the second end of the ion mirrors is opposed by an electric field resulting from the non-constant distance of the two mirrors from each other, and this electric field causes the ions to reverse their drift direction velocity in proximity with the second end of the ion mirrors and drift back along the drift direction towards the deflector 37.

The analyser depicted in FIG. 2, further comprises a pair of correcting stripe electrodes 39. Ions travelling down the drift length are slightly deflected with each pass through the mirrors 31, 32 and the additional stripe electrodes 39 are used to correct for the time-of-flight error created by the varying distance between the mirrors. For example, the stripe electrodes 39 may be electrically biased such that the period of ion oscillation between the mirrors is substantially constant along the whole of the drift length (despite the non-constant distance between the two mirrors from). The ions eventually find themselves reflected back down the drift space and focused at the detector 38.

Further detail of the tilted-mirror type multireflection time-of-flight mass analyser of FIG. 2 is given in U.S. Pat. No. 9,136,101.

It should be noted that in general the analyser 30 can be any suitable type of time-of-flight (ToF) mass analyser (or indeed an ion mobility analyser). For example, the analyser may be a single-lens type multireflection time-of-flight mass analyser, e.g. as described in UK Patent No. GB 2,580,089.

In general, time-of-flight (ToF) mass analysers with ion-impact detectors utilise the property that the travelling time of an ion in an electrostatic field is proportional to the square root of the ion's mass to charge ratio (m/z). Ions are ejected simultaneously from an ion source (e.g., an orthogonal accelerator or a radio-frequency ion trap), accelerated to a desirable energy, and impinge upon an ion detector after traveling a specified distance.

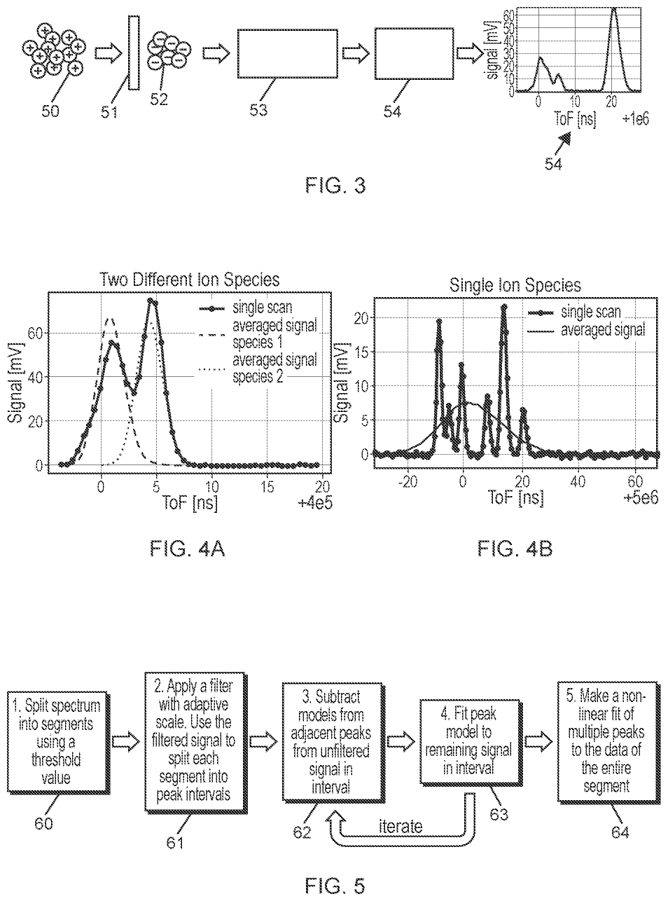

FIG. 3 illustrates schematically the process of a packet of ions 50 being detected by the detector. As shown in FIG. 3, the detector comprises a conversion dynode 51 followed by one or more electron multiplier stages 53. The detector may also or instead include one or more scintillators and/or one or more photon multipliers, etc. In the embodiment depicted in FIG. 3, the ions 50 are caused to impact upon the conversion dynode 51, whereupon secondary electrons 52 are produced. The secondary electrons 52 are then amplified by the one or more stages of electron multiplication 53, so as to produce a signal indicative of the intensity of the ions 50 received at the conversion dynode 51 as a function of time.

The generated signal is recorded by data acquisition electronics 54 such as a digitiser, e.g. either a time-to-digital converter (TDC) or an analogue-to-digital converter (ADC). As shown in FIG. 3, this results in time resolved peaks 55 generated by ions of the same mass-to-charge ratio. As the travelling distance is substantially the same for all of the ions 50, the ion arrival time is used to determine the mass-to-charge ratio (m/z) of the ions, which can then be used for ion identification.

ToF mass analysers typically record signals at a rate of between around 100 Hz and 10 kHz, with each signal potentially containing hundreds of different ion peaks. Each signal corresponds to a respective packet of ions 50 ejected by the injector 33 into the analyser. It can be desirable to analyse these signals in real-time, e.g. so that the parameters for subsequent scans can be set based on the results of the analysis.

However, the peaks recorded by the data acquisition electronics 54 can have complicated shapes, and peaks deriving from different ion species can overlap. Therefore, embodiments provide a method of identifying peaks corresponding to different mass-to-charge ratios from the recorded signal, and then assigning an arrival time, intensity, and/or one or more other properties to each of these peaks.

Two edge-cases that the peak fitting method should address can be identified. These are illustrated by FIG. 4.

As shown in FIG. 4A, in the first edge-case, two overlapping peaks are generated by two different ion species with similar mass-to-charge ratios. The overlapping peaks should be disentangled to estimate the arrival time and/or other parameters for each of the two species individually.

As shown in FIG. 4B, in the second edge-case, a single ion species generates a multi-modal peak, where this peak should not be interpreted as signal resulting from different ion species (as in the first case), but should be treated as being a signal originating from a single species only. It should be noted that if multiple signals were averaged or if more ions were present in the signal, the multi-modal structure of this peak would disappear.

This second case is of particular relevance to multi-reflection time-of-flight (MR-ToF) analysers. As described above, in these instruments, the ion trajectories are folded using multiple reflections between ion mirrors 31, 32 to achieve a long travelling distance and therefore a long time of flight T. In this case, a rather broad probability distribution for the ion arrival time of width ΔT can still lead to a very high resolution, which is proportional to the ratio ΔT/T.

On the other hand, state-of-the-art ion detectors convert incident ions into voltage pulses with a full-width-half-maximum (FWHM) below 1 ns, which can be considerably less than ΔT for MR-ToF instruments. In this case, if only a few ions of a species are detected, it is very probable that a multi-modal signal, such as the signal shown in FIG. 4B, will be recorded. Only if many such signals were averaged would a unimodal peak emerge having a similar shape to the arrival time distribution. However, averaging is time consuming, and may be omitted whenever possible to achieve a fast analysis of a given sample. Similarly, a larger number of ions and a better signal-to-noise ratio would reduce the chance of encountering multimodal peaks, but this cannot always be achieved.

The width of the arrival time distribution typically depends on the arrival time itself. This results in peaks of vastly different widths if a large mass-to-charge range is analysed. Especially for large mass-to-charge ratio ions, broad probability distributions of the ion arrival time can be expected, leading to multimodal signals generated by only a single ion species.

These multi-modal peaks can arise from ions of a single species due to poor ion statistics and noise, and the modes of such peaks can easily be misinterpreted as multiple overlapping peaks. To avoid this, smoothing spline functions (e.g. Chudinov, A. V., et al. “Interpolational and smoothing cubic spline for mass spectrometry data analysis.” International Journal of Mass Spectrometry 396 (2016): 42-47), continuous wavelet transformations (e.g. Du, Pan, Warren A. Kibbe, and Simon M. Lin. “Improved peak detection in mass spectrum by incorporating continuous wavelet transform-based pattern matching.” Bioinformatics 22.17 (2006): 2059-2065; and Lange, Eva, et al. “High-accuracy peak picking of proteomics data using wavelet techniques.” Biocomputing 2006. 2006. 243-254), and discrete wavelet transformations (e.g. Coombes, Kevin R., et al. “Improved peak detection and quantification of mass spectrometry data acquired from surface-enhanced laser desorption and ionization by denoising spectra with the undecimated discrete wavelet transform.” Proteomics 5.16 (2005): 4107-4117) have been used in the prior art to separate signal and noise and to search for ion peaks on different scales. However, the inventors have found that performing filtering on different scales and searching for peaks on all of the scales can be very time consuming, and so is not suitable for a real-time analysis of spectra recorded at a rate of 100 Hz to 10 kHz.

US Patent Application No. US 2009/0072134 uses a mass dependent binning of the incoming data such that every peak across the full mass range has a similar FWHM in terms of number of bins. However, this results in information being lost during the binning process.

Thus, prior art methods either perform an analysis on many different scales which is computationally expensive, or use binning which results in a loss of precision.

FIG. 5 shows a method according to various embodiments. The approach does not require a smoothing technique on different scales and reduces the probability of incorrectly interpreting a multimodal peak as being overlapping peaks of different ion species. FIG. 5 is a flow chart illustrating the main steps of the algorithm according to various embodiments.

As shown in FIG. 5, in a first step 60, the spectrum is cut into different segments using a threshold. Only samples above the threshold together with some adjacent samples are retained. This step can be readily implemented in the firmware of the ADC 54.

In a second step 61, a Gaussian filter is applied to the raw data of each segment. If the width of the smoothing kernel is on the order of the width of the arrival time distribution in this segment, the filter will typically turn multi-modal peaks into a unimodal peak. This avoids false identification of multiple peaks.

To find the correct width of the arrival-time distribution of an ion of a given arrival time, a calibration is performed for the ToF analyser. This prior knowledge enables the algorithm to look for a peak on a specific scale rather than looking for peaks on all scales like in the prior art, and thereby considerably speeds up the analysis.

In some embodiments, it has been found to be sufficient to assume a linear dependency. Thus, the width δt of the smoothing kernel may be proportional to the mean arrival time T in the current segment. The factor between these two may be called the “time-scale factor”. In embodiments, this factor may be on the order of 1e⁻⁶.

A slightly more sophisticated model may be used, e.g., of the form

$$δ t ∝ \sqrt{δ {t}_{min}^{2} + {( \frac{T}{2 R} )}^{2}} .$$

Here, δtₘᵢₙ is the peak width that can be obtained at short time-of-flight, limited by effects like the initial energy and position spread of the ions, whereas

$$R = \frac{T}{2 δ t}$$

refers to the resolution at high mass to charge ratio, which is mainly limited by differences in the ion path length due to aberrations in the instrument. Other parameters, like the number of ions, influence the width and shape of the distribution too, but are found to be less important.

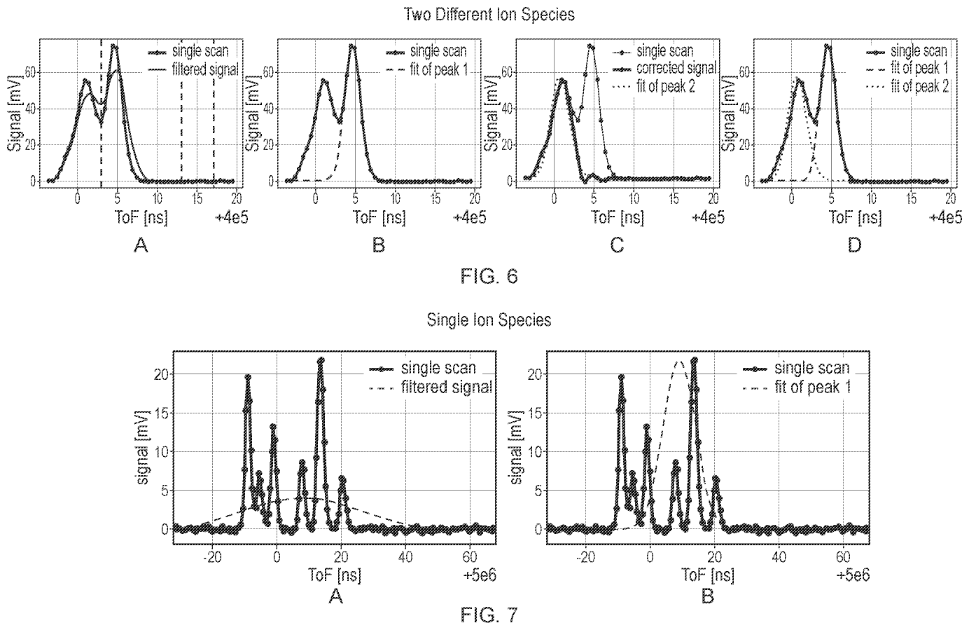

Once the segment has been filtered, local minima in the filtered signal are found, and the segment is further divided into multiple intervals at the location of these minima. This is illustrated by FIG. 6A.

It will be understood that, in essence, the Gaussian filter is a pattern matching giving a maximum at the position of the peaks and minima in between. To improve this further, it is beneficial to use a model of the arrival-time distribution as a smoothing kernel. In embodiments, the arrival-time distribution can be well-modelled by an asymmetric Gaussian function, with a different value for sigma to the left and right of its centre, and this model may be used as a smoothing kernel.

As an alternative to the Gaussian filter in the second step 61, a continuous wavelet transformation (CWT) can be applied, where the scale of the wavelet is again proportional to the mean arrival time in the current segment. Using the Marr wavelet (also known as the Mexican-hat wavelet), a filtered second derivative of the signal is obtained. The local maxima of the transformed signal are assumed to be a first estimate of the peak positions if they exceed a threshold. The splitting is then done between these estimated peak positions. Using CWT, two peaks can be identified in situations where there is no local minimum between the two peaks.

In the third 62 and fourth 63 steps, only intervals in which the maximum intensity value exceeds a given threshold are kept, and the remaining intervals are processed one-by-one.

If the signal in the segment originates from a single ion-species only, only a single interval should be left at this point, and so the parameters of only a single peak should then be estimated. This situation is illustrated by FIG. 7.

If multiple intervals remain, they are sorted according to the summed-up signal from highest to lowest, and then the algorithm estimates the parameters of the peaks in each of these intervals one by one as follows.

Suppose the peak parameters in interval k having raw unfiltered samples of height yᵢ recorded at flight times tᵢ are to be estimated. In the third step 62, the model values fₗ(tᵢ) are firstly subtracted at these flight times from other peaks that have already been estimated to obtain ŷᵢ=yᵢ−Σ_{l≠k}fₗ(tᵢ). An example of such a corrected signal is shown in FIG. 6C.

In the fourth step 63, the parameters of the peaks are estimated using the remaining signal ŷᵢ. To find the peak centre T in a given interval, many methods may be used. Two of these methods are:
1. Calculation of the centre of gravity T=Σᵢtᵢ−ŷᵢ/Σᵢtᵢ.
2. Calculation of the mid-point where the cumulative sum Σ_{i>j}ŷᵢ reaches half of the total signal.

Here tᵢ and yᵢ are the sample time and voltage. The maximum of the peak yₘₐₓ is assumed to be equal to the maximum signal observed in this interval of the segment.

Alternatively, the signal at the estimated peak centre could be used. The width of the left σ_{g} and right part σᵣ of the asymmetric peak is adjusted such that the integrated area of the model and the observed data to the left and to the right of the estimated peak centre is the same. These parameters lead to the following model of the peak:

$${f}_{k} ( {t}_{i} ) = {y}_{max} exp ( - \frac{{( {t}_{i} - T )}^{2}}{2 {σ ( {t}_{i} )}^{2}} ) with σ ( {t}_{i} ) = \{ \begin{matrix}{σ}_{l} & if {t}_{i} < T \\ {σ}_{r} & if {t}_{i} > T\end{matrix}$$

In a similar manner, parameters of other models may be estimated.

It should be noted that in embodiments, the filtered version of a segment is only used for splitting the peaks, and is not used for fitting the model. Instead, the model is fitted to the original unfiltered segment of data. This ensures that resolution is retained.

After a model is obtained for every peak, the estimations can optionally be iterated. For these additional iterations, the full segment may be used instead of an interval only. However, it was found to be sufficient to only use the data from the corresponding intervals. The iteration(s) may be terminated when the parameters reach the desired precision, or when a defined maximum number of iterations is reached. The result of this iteration is shown in FIG. 6D.

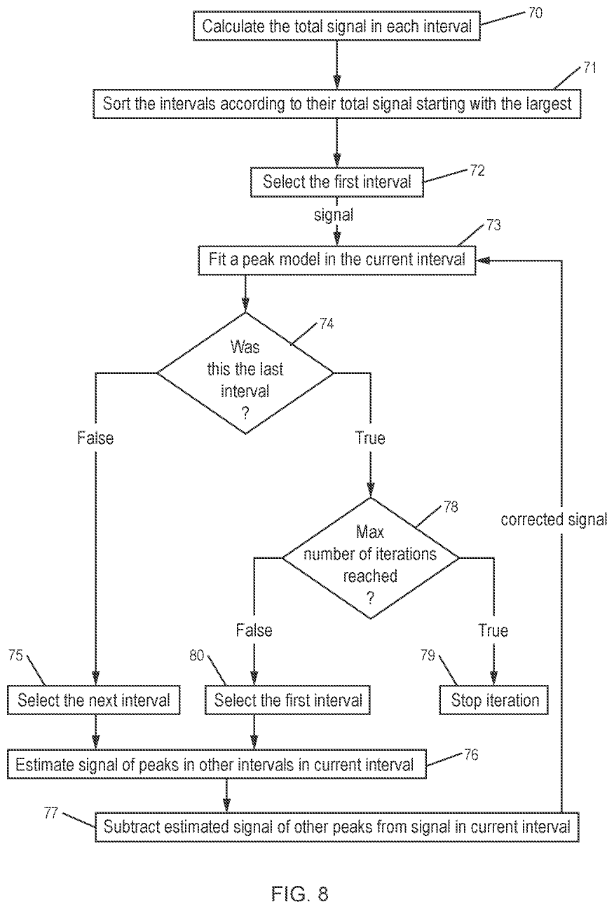

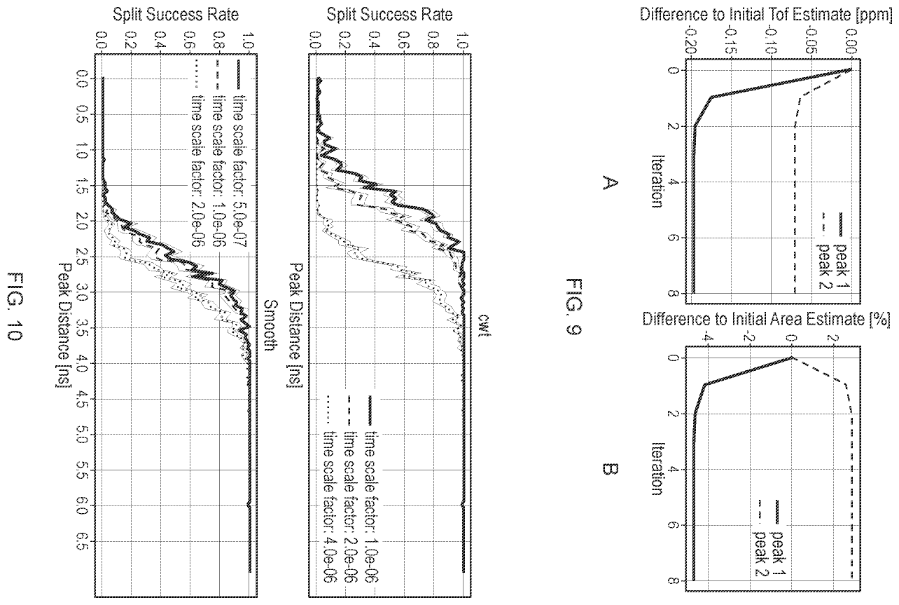

FIG. 8 is a flow diagram that illustrates detail of the iterative process of the third 62 and fourth 63 steps of the method in the situation where multiple intervals remain. As shown in FIG. 8, the total signal for each remaining interval is calculated (step 70), and the intervals are sorted according to their total signal in order from the highest to the lowest (step 71). The algorithm initially selects the interval with the highest total signal (step 72), and fits a peak model to that interval (step 73).

Next, a determination is made as to whether the current interval is the last interval (step 74). Where this is not the case, the interval with the next highest sum is selected (step 75). Then, the algorithm makes an estimate of the amount of signal originating from peaks in other intervals of the segment that appears in the current interval (step 76), and subtracts that estimated signal from the signal in the current interval (step 77). The algorithm then loops back to step 73, by fitting a peak model to the corrected signal for the current interval produced by step 77.

This process is looped by stepping through each interval one by one, until the last interval is reached, at which point step 74 will determine that the current interval is the last interval. Next, a determination is made as to whether the maximum number of iterations has been reached (step 78). Where this is the case, the process is ended (step 79), and the current set of peak models is output and/or used for further analysis.

On the other hand, where the maximum number of iterations has not been reached, the entire procedure is iterated, starting back with the interval with the highest total signal (step 80). However, in this case, as can be seen from FIG. 8, the first interval is subjected to steps 76 and 77 (i.e. by subtracting, from the signal of the current interval, an estimated amount of signal originating from peaks in other intervals of the segment that appears in the current interval) before a peak model is fitted to the corrected signal in step 73.

Although in the embodiment depicted in FIG. 8, the iteration is terminated after a maximum number of iterations, it would instead be possible to utilise more sophisticated termination criteria, e.g. based on a desired precision for the parameter(s) determined from the peak model(s) (e.g. centroid, intensity and/or area).

FIG. 9 shows the convergence of the estimated ToF centroid and peak area for the example from FIG. 6 after a number of iterations. As can be seen from FIG. 9, typically only a few iterations are needed for the estimations to converge, and even the initial estimate is already close enough for many applications.

Returning to FIG. 5, an optional final step 64 may be performed, whereby a nonlinear fit of the full segment to a multi-peak model is made. The initial values for the non-linear fit are obtained from the previous step 63. This additional step 64 can be time consuming, and good agreement between the raw data in the model after the previous step 63 is usually found. Therefore, this last step 64 may only be performed if time allows. The resulting final model is shown in FIG. 6D.

The performance of the algorithm was evaluated using recorded data of a TMT sample, as well as simulated peaks which allow the peak properties to be arbitrarily adjusted (most importantly the distance between two peaks). Using simulated data, it was found that at a time-of-flight of ˜300 μs and a resolution of 100,000 (corresponding to a FWHM of 1.5 ns), two peaks containing 10 ions on average with a ToF difference of 4 ns can still be reliably distinguished for appropriate parameters. This is shown in FIG. 10. The split success rate is defined as the fraction of segments that are correctly split into two peaks. Using the CWT, even lower values can be achieved in situations where no local minimum between the peaks is observed.

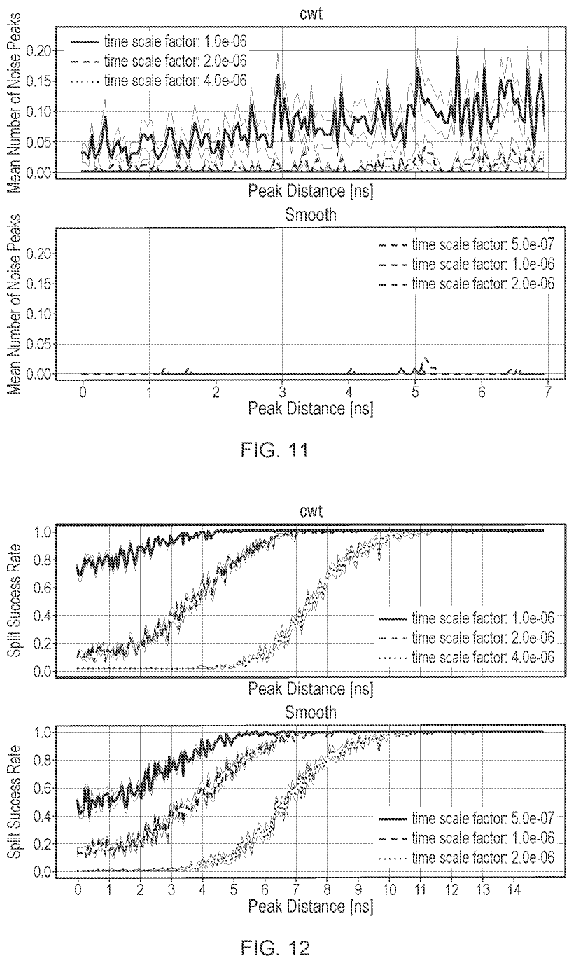

While the true positive rate increases when reducing the time scale factor, FIG. 11 shows that for the same data, the mean number of false positives per scan also increases, especially when using CWT.

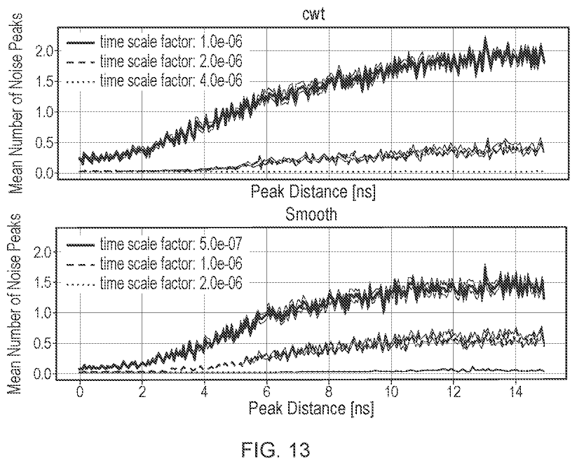

In FIGS. 12 and 13, the false positive rate is plotted for two peaks with ToF˜1000 μs. This clearly shows that increasing the ToF and thereby the peak width, leads to more false positives. Reducing the number of ions further leads to similar problems. A good balance between false positives and false negatives should be found. To combine these objectives, the accuracy is defined as TP/TP+FP, where TP is the number of successful splits in at least two peaks, and FP is the number of excessive peaks.

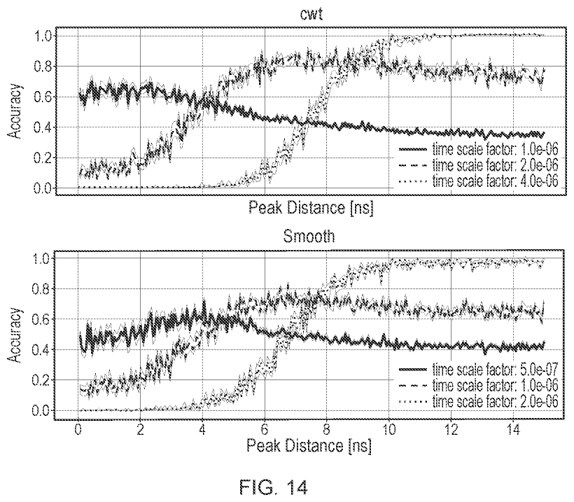

The accuracy is shown in FIG. 14. A time scale factor of 3e⁻⁶ was chosen to safely achieve the maximum accuracy at larger peak distances.

It should be noted that all of the steps of the algorithm according to embodiments can be implemented in a very efficient way, and are not computationally expensive. It was possible to demonstrate that the analysis of a segment containing two peaks takes on average 4 μs in a C++ implementation if the last optional step 64 of a non-linear fit is excluded. Implementations faster than 4 μs are possible.

In an extreme case, there can be about 500, 1000, or more peaks in a spectrum, typically recorded in a first channel with high gain and in a second channel with low gain simultaneously to increase the dynamic range. Thus, about 1000 or more segments may need to be analysed, which allows for an online analysis of the incoming data.

It will be appreciated that embodiments use either a CWT or a low-pass filter with a scale that depends on the time-of-flight or m/z, to split the signal into peaks originating from different ion species. The correct scale is chosen to avoid false detection of multiple species due to poor ion statistics.

Although the present invention has been described with reference to various embodiments, it will be understood that various changes may be made without departing from the scope of the invention as set out in the accompanying claims.

1. A method of analysing data generated by an ion analyser, the method comprising:
(i) receiving a first segment of data generated by an ion analyser, wherein the first segment of data comprises data associated with a first arrival time range;
(ii) applying a filter to the first segment of data so as to produce a filtered version of the first segment of data, wherein a width associated with the filter is configured to depend upon a width of an expected ion arrival time distribution for the ion analyser for arrival times within the first arrival time range;
(iii) identifying one or more ion peaks in the filtered version of the first segment of data; and
(iv) determining one or more characteristics of each ion peak of the one or more identified ion peaks.

2. The method of claim 1, further comprising:
(i) receiving a second segment of data generated by the ion analyser, wherein the second segment of data comprises data associated with a second different arrival time range;
(ii) applying the filter to the second segment of data so as to produce a filtered version of the second segment of data, wherein the width associated with the filter is configured to depend upon a width of an expected ion arrival time distribution for the ion analyser for arrival times within the second different arrival time range;
(iii) identifying one or more ion peaks in the filtered version of the second segment of data; and
(iv) determining one or more characteristics of each ion peak of the one or more identified ion peaks.

3. The method of claim 2, wherein:
the first segment of data and the second segment of data are derived from a signal produced by the ion analyser in response to detecting a single packet of ions; or
the first segment of data and the second segment of data are derived from a signal produced by combining multiple signals produced by the ion analyser.

4. The method of claim 3, wherein the method comprises generating the first segment of data or the second segment of data when an intensity of the signal exceeds a threshold.

5. The method of claim 2, wherein:
the first segment of data comprises a first set of digital samples, wherein each sample of the first set is associated with a respective arrival time, and wherein the arrival times associated with the first set are within the first arrival time range; or
the second segment of data comprises a second set of digital samples, wherein each sample of the second set is associated with a respective arrival time, and wherein the arrival times associated with the second set are within the second different arrival time range.

6. The method of claim 1, wherein the width associated with the filter is configured to depend upon the arrival time range associated with the segment.

7. The method of claim 6, wherein the width associated with the filter is configured to depend upon a mean arrival time associated with the segment.

8. The method of claim 1, wherein the expected ion arrival time distribution for the ion analyser is determined from a calibration for the ion analyser.

9. The method of claim 1, wherein the filter utilises a Gaussian smoothing function, an asymmetric Gaussian smoothing function, or a continuous wavelet transformation (CWT).

10. The method of claim 1, wherein identifying one or more ion peaks in the filtered version of the segment of data comprises:
identifying one or more local minima, zero-crossing points and/or local maxima in the filtered version of the segment of data, and dividing the segment into one or more intervals at the location of one or more of the identified minima, zero-crossing points and/or maxima; and
retaining only interval(s) with a maximum sample intensity above a threshold.

11. The method of claim 10, further comprising:
in response to a single interval being retained in the segment, determining one or more characteristics of an ion peak in the interval by fitting a peak model to the samples of the interval, wherein the one or more characteristics comprise a centroid, intensity and/or area of the ion peak.

12. The method of claim 10, further comprising, in response to multiple intervals being retained for the segment:
for each remaining interval, summing the intensities of the samples within that interval;
fitting a first peak model to the samples of the interval with the highest sum;
using the first peak model for the interval with the highest sum to modify the samples of the interval with the second highest sum; and
fitting a second peak model to the modified samples of the interval with the second highest sum.

13. The method of claim 12, further comprising, for each interval of any remaining interval(s) of the segment other than an interval with the highest sum and an interval with the second highest sum, performing the following steps (a) and (b):
(a) modifying the samples of the interval with the next highest sum using the first peak model for the interval with the highest sum, the second peak model for the interval with the second highest sum, and any other peak model(s) that have been determined for other intervals of the segment; and
(b) fitting a peak model to the modified samples of the interval.

14. The method of claim 12, further comprising, when a set of peak models has been produced by fitting a peak model to each of the multiple remaining intervals:
(c) using the peak models of the set other than the first peak model to modify the samples of the interval with the highest sum;
(d) fitting a first modified peak model to the modified samples of the interval with the highest sum, and replacing the first peak model with the first modified peak model in the set of peak models;
(e) using the peak models of the set other than the second peak model to modify the samples of the interval with the second highest sum; and
(f) fitting a second modified peak model to the modified samples of the interval with the second highest sum, and replacing the second peak model with the second modified peak model in the set of peak models;
(g) for each interval of any remaining interval(s) of the segment other than the interval with the highest sum and the interval with the second highest sum, performing the following steps (h) and (i):
(h) modifying the samples of the interval with the next highest sum using the peak models of the set other than the peak model for the current interval; and
(i) fitting a peak model to the modified samples of the current interval, and replacing the peak model for the current interval with the modified peak model for the current interval in the set of peak models.

15. The method of claim 14, further comprising iterating steps (c) to (i) one or more times.

16. The method of claim 12, further comprising fitting a multiple-peak model to the samples of the segment after a peak model has been fitted to each of the multiple remaining intervals.

17. The method of claim 1, further comprising using the one or more determined characteristics of each ion peak to determine a physicochemical property of ions associated with the ion peak.

18. A method of operating an analytical instrument that comprises an ion source and an ion analyser, the method comprising:
generating ions in the ion source;
analysing the ions with the ion analyser so as to generate data; and
analysing the data using the method of claim 1.

19. A non-transitory computer readable storage medium storing computer software code that, when executed on a processor, causes the processor to:
(i) receive a first segment of data generated by an ion analyser, wherein the first segment of data comprises data associated with a first arrival time range;
(ii) apply a filter to the first segment of data so as to produce a filtered version of the first segment of data, wherein a width associated with the filter is configured to depend upon a width of an expected ion arrival time distribution for the ion analyser for arrival times within the first arrival time range;
(iii) identify one or more ion peaks in the filtered version of the first segment of data; and
(iv) determine one or more characteristics of each ion peak of the one or more identified ion peaks.

20. An analytical instrument comprising:
an ion analyser; and
a control system configured to:
(i) receive a segment of data generated by the ion analyser, wherein the segment of data comprises data associated with a first arrival time range;
(ii) apply a filter to the segment of data so as to produce a filtered version of the segment of data, wherein a width associated with the filter is configured to depend upon a width of an expected ion arrival time distribution for the ion analyser for arrival times within the first arrival time range;
(iii) identify one or more ion peaks in the filtered version of the segment of data; and
(iv) determine one or more characteristics of each ion peak of the one or more identified ion peaks.
